(19) United States
(12) Patent Application Publication
(10) Pub. No.: US 2021/0163719 A1
(43) Pub. Date: Jun. 3, 2021

(54) SIDE REINFORCEMENT RUBBER COMPOSITION FOR RUN-FLAT TIRE, SIDE REINFORCEMENT RUBBER FOR RUN-FLAT TIRE, AND RUN-FLAT TIRE

(71) Applicant: BRIDGESTONE CORPORATION, Tokyo (JP)

(72) Inventor: Noritoshi NUKUI, Chuo-ku, Tokyo (JP)

(73) Assignee: BRIDGESTONE CORPORATION, Tokyo (JP)

(21) Appl. No.: 16/769,036

(22) PCT Filed: Sep. 7, 2018
(86) PCT No.: PCT/JP2018/033193

§ 371 Date: Jun. 2, 2020

(30) Foreign Application Priority Data
Dec. 7, 2017 (JP) 2017-235306

(51) Int. Cl. C08L 9/00; B60C 1/00

(52) U.S. Cl. CPC C08L 9/00; B60C 2001/0033; B60C 1/00

(57) ABSTRACT

The present invention relates to a side reinforcing rubber composition for run flat tires, containing a rubber component; a filler containing a carbon black A having a nitrogen adsorption specific surface area of 20 to 60 m²/g and a carbon black B having a nitrogen adsorption specific surface area of 100 to 150 m²/g, a ratio (a/b) of the content a of the carbon black A to the content b of the carbon black B being 2.7 to 10; a vulcanizing agent; and a vulcanization accelerator, the side reinforcing rubber composition for run flat tires being able to produce a side reinforcing rubber for run flat tires capable of enhancing the run flat durability.

### TECHNICAL FIELD

The present invention relates to a side reinforcing rubber composition for run flat tires, a side reinforcing rubber for run flat tires, and a run flat tire.

### BACKGROUND ART

In order to enhance the rigidity of the side wall part of a tire, particularly of a run flat tire, a side reinforcing layer using a rubber composition alone or a composite of a rubber composition, a fiber, and the like, has been conventionally arranged.

For example, in PTL 1, the run flat durability is enhanced by providing a pneumatic tire using a rubber composition (Z) having specified phenol resin and methylene donor blended in a rubber composition (Y) in which with respect to vulcanized rubber physical properties, an elastic modulus at 100% elongation is a certain value or more, and a Σ value of a tangent loss tan δ at 28° C. to 150° C. is a certain value or less, especially for a side reinforcing rubber layer and/or a bead filler.

In addition, in PTL 2, the run flat durability is enhanced by a rubber composition containing 40 to 80 parts by weight of carbon black having a nitrogen adsorption specific surface area (N2SA) of 20 m²/g or more and less than 30 m²/g and a dibutyl phthalate (DBP) absorption of 50 to 155 cm³/100 g based on 100 parts by weight of a diene-based rubber component containing 15 to 50 parts by weight of a butadiene rubber or a styrene-butadiene rubber which is polymerized using an organic lithium catalyst, and in which its molecular end is tin-modified or hydroxy group-modified with a modifier, the rubber composition having a loss tangent (tan δ) measured at 70° C. being less than 0.07.

### CITATION LIST

### Patent Literature

PTL 1: JP 2010-155550 A

PTL 2: JP 2009-113793 A

### SUMMARY OF INVENTION

### Technical Problem

However, along with the improvement in performance of automobiles, particularly passenger cars, a further improvement in the run flat durability is required.

A problem of the present invention is to provide a side reinforcing rubber for run flat tires capable of enhancing the run flat durability, a side reinforcing rubber composition for run flat tires capable of producing the same, and a run flat tire which is excellent in run flat durability.

### Solution to Problem

<1> A side reinforcing rubber composition for run flat tires, containing a rubber component; a filler containing a carbon black A having a nitrogen adsorption specific surface area of 20 to 60 m²/g and a carbon black B having a nitrogen adsorption specific surface area of 100 to 150 m²/g, a ratio (a/b) of the content a of the carbon black A to the content b of the carbon black B being 2.7 to 10; a vulcanizing agent; and a vulcanization accelerator.
<2> The side reinforcing rubber composition for run flat tires as set forth in <1>, wherein the nitrogen adsorption specific surface area of the carbon black A is 30 to 50 m²/g, and the nitrogen adsorption specific surface area of the carbon black B is 110 to 130 m²/g.
<3> The side reinforcing rubber composition for run flat tires as set forth in <1> or <2>, wherein a total amount of the content a of the carbon black A and the content b of the carbon black B is 30 to 80 parts by mass based on 100 parts by mass of the rubber component.
<4> The side reinforcing rubber composition for run flat tires as set forth in any one of <1> to <3>, wherein the vulcanizing agent is sulfur, the vulcanization accelerator is a thiuram-based vulcanization accelerator, and a ratio (s/t) of the content s of the sulfur to the content t of thiuram-based vulcanization accelerator is 1 to 10.
<5> The side reinforcing rubber composition for run flat tires as set forth in any one of <1> to <4>, wherein as vulcanized rubber characteristics, a 50% modulus value at 25° C. is 4.0 to 6.0 MPa.
<6> The side reinforcing rubber composition for run flat tires as set forth in any one of <1> to <5>, wherein the ratio (a/b) of the content a of the carbon black A to the content b of the carbon black B is 3.1 to 10.
<7> A side reinforcing rubber for run flat tires using the side reinforcing rubber composition for run flat tires as set forth in any one of <1> to <6> and having a 50% modulus value at 25° C. of 4.0 to 6.0 MPa.
<8> A run flat tire using the side reinforcing rubber for run flat tires as set forth in <7>.

### Advantageous Effects of Invention

In accordance with the present invention, it is able to provide a side reinforcing rubber for run flat tires capable of enhancing the run flat durability, a side reinforcing rubber composition for run flat tires capable of producing the same, and a run flat tire which is excellent in run flat durability.

### BRIEF DESCRIPTION OF DRAWING

FIG. 1 is a schematic view showing a cross section in one embodiment of the run flat tire of the present invention.

### DESCRIPTION OF EMBODIMENTS

### <Side Reinforcing Rubber Composition for Run Flat Tires>

The side reinforcing rubber composition for run flat tires of the present invention contains a rubber component; a filler containing a carbon black A having a nitrogen adsorption specific surface area of 20 to 60 m²/g and a carbon black B having a nitrogen adsorption specific surface area of 100 to 150 m²/g, a ratio (a/b) of the content a of the carbon black A to the content b of the carbon black B being 2.7 to 10; a vulcanizing agent; and a vulcanization accelerator.

Hereinafter, the side reinforcing rubber composition for run flat tires, the side reinforcing rubber for run flat tires, and the run flat tire will be sometimes referred to simply as “rubber composition”, “side reinforcing rubber”, and “tire”, respectively.

The carbon black has a large interaction with the rubber component, and therefore, it may be considered that the rubber component readily adsorbs onto the surroundings of carbon black particles. In view of the fact that the rubber components adsorbed onto the carbon black particles readily interact with each other, a network between the rubber component and the carbon black becomes enriched, and the reinforcement of the rubber component is enhanced.

As expressed in PTLs 1 and 2 as mentioned already conventionally only one kind of carbon black was used for the side reinforcing rubber composition for run flat tires, and thus, it may be considered that a gap is formed between the carbon black particles, so that the network between the rubber component and the carbon black was insufficient.

In contrast, the side reinforcing rubber composition for run flat tires of the present invention contains a large-particle-diameter carbon black A having a nitrogen adsorption specific surface area of 20 to 60 m²/g and a small-particle-diameter carbon black B having a nitrogen adsorption specific surface area of 100 to 150 m²/g. For that reason, the small-particle-diameter carbon black B is able to intervene in a gap formed between the particles of the large-particle-diameter carbon black A. Furthermore, in view of the fact that the carbon blacks A and B are contained in a specified ratio, the network between the rubber component and the carbon black can be made enriched, and therefore, it may be considered that a side reinforcing rubber for run flat tires having higher rigidity than a tire tread rubber can be produced.

As a result, in accordance with the rubber composition of the present invention, it may be considered that a side reinforcing rubber for run flat tires capable of enhancing the run flat durability can be produced, and a run flat tire provided with the foregoing side reinforcing rubber for run flat tires which is excellent in run flat durability.

The tire rubber composition, the side reinforcing rubber and the tire of the present invention will be described in detail below.

### [Rubber Component]

The side reinforcing rubber composition for run flat tires of the present invention contains at least a rubber component.

Although it is preferred that the rubber component contains a diene-based rubber, it may also contain a non-diene-based rubber to an extent that the effects of the present invention are not impaired.

As the diene-based rubber, at least one selected from the group consisting of a natural rubber (NR) and a synthetic diene-based rubber is used.

Specifically, examples of the synthetic diene-based rubber include a polyisoprene rubber (IR), a polybutadiene rubber (BR), a styrene-butadiene copolymer rubber (SBR), a butadiene-isoprene copolymer rubber (BIR), a styrene-isoprene copolymer rubber (SIR), and a styrene-butadiene-isoprene copolymer rubber (SBIR).

As the diene-based rubber, a natural rubber, a polyisoprene rubber, a styrene-butadiene copolymer rubber, a polybutadiene rubber, and an isobutylene-isoprene rubber are preferred, and a natural rubber and a polybutadiene rubber are more preferred. The diene-based rubbers may be used alone or may be used as a blend of two or more thereof.

As the diene-based rubber, though only either one of a natural rubber and a synthetic diene-based rubber may be used, or the both may be used, from the viewpoint of more enhancing the run flat durability, it is preferred to use a combination of a natural rubber and a synthetic diene-based rubber.

From the same viewpoint, in the rubber component, it is preferred that the content of the natural rubber is 10 to 50% by mass, and the content of the synthetic diene-based rubber is 50 to 90% by mass; and it is more preferred that the content of the natural rubber is 20 to 40% by mass, and the content of the synthetic diene-based rubber is 60 to 80% by mass.

From the viewpoint of enhancing the run flat durability the synthetic diene-based rubber preferably contains a modified rubber, and more preferably contains an amine-modified conjugated diene-based polymer having been subjected to amine modification.

As the amine-modified conjugated diene-based polymer, ones having a primary amino group protected with a removable group or a secondary amino group protected with a removable group as an amine-based functional group for modification introduced in the molecule are preferred, and ones in which a silicon atom-containing functional group is further introduced are preferably exemplified.

Examples of the primary amino group protected with a removable group (also referred to as “protected primary amino group”) include a N,N-bis(trimethylsilyl)amino group, and examples of the secondary amino group protected with a removable group include a N,N-(trimethylsilyl)alkylamino group. The N,N-(trimethylsilyl)alkylamino group-containing group may be any of a non-cyclic residue and a cyclic residue.

Among the aforementioned amine-modified conjugated diene-based polymers, a primary amine-modified conjugated diene-based polymer modified with a protected primary amino group is more suitable.

Examples of the silicon atom-containing functional group include a hydrocarbyloxysilyl group and/or a silanol group, in which a hydrocarbyloxy group and/or a hydroxy group is bonded to a silicon atom.

Such a functional group for modification may be present at any of the polymerization initiation end, the side chain, and the active polymerization end of a conjugated diene-based polymer. In the present invention, the functional group for modification has an amino group protected with a removable group and at least one (e.g., one or two) silicon atom to which a hydrocarbyloxy group and a hydroxy group are bonded, preferably at the polymerization end, and more preferably at the same active polymerization end.

### (Conjugated Diene-Based Polymer)

The conjugated diene-based polymer which is used for modification of the modified rubber may be a homopolymer of conjugated diene compound or a copolymer of two or more conjugated diene compounds, and it may also be a copolymer of a conjugated diene compound and an aromatic vinyl compound.

Examples of the conjugated diene compound include 1,3-butadiene, isoprene, 1,3-pentadiene, 2,3-dimethyl-1,3-butadiene, 2-phenyl-1,3-butadiene, and 1,3-hexadiene. Although these may be used alone or may be used in combination of two or more thereof, among them, 1,3-butadiene is especially preferred.

Examples of the aromatic vinyl compound which is used for copolymerization with the conjugated diene compound include styrene, α-methylstyrene, 1-vinylnaphthalene, 3-vinyltoluene, ethylvinylbenzene, divinylbenzene, 4-cyclohexylstyrene, and 2,4,6-trimethylstyrene. Although these may be used alone or may be used in combination of two or more thereof, among them, styrene is especially preferred.

As the conjugated diene-based polymer, at least one conjugated diene-based polymer selected from the group consisting of polybutadiene, polyisoprene, an isoprene-butadiene copolymer, an ethylene-butadiene copolymer, a propylene-butadiene copolymer, and a styrene-butadiene copolymer is preferred, and polybutadiene is especially preferred.

In order to allow an active end of the conjugated diene-based polymer to react with a protected primary amine to undergo the modification, the foregoing conjugated diene-based polymer is preferably one provided with living properties or pseudo-living properties in at least 10% of polymer chains. Examples of the polymerization reaction proving such living properties include a reaction in which a conjugated diene compound alone or a conjugated diene compound and an aromatic vinyl compound are subjected to anionic polymerization in an organic solvent using an organic alkali metal compound as an initiator; and a reaction in which a conjugated diene compound alone or a conjugated diene compound and an aromatic vinyl compound are subjected to coordinate anionic polymerization in an organic solvent in the presence of a catalyst containing a lanthanum series rare earth element compound. The former is preferred because it can provide a polymer having a high content of a vinyl bond in the conjugated diene moiety as compared with that in the latter. The heat resistance can be enhanced by increasing the vinyl bond amount.

The organic alkali metal compound which is used as the initiator for the anionic polymerization is preferably an organic lithium compound. Although the organic lithium compound is not particularly limited, hydrocarbyllithium and a lithium amide compound are preferably used. When hydrocarbyllithium of the former is used, a conjugated diene-based polymer which has a hydrocarbyl group at a polymerization initiation end and in which the other end is a polymerization active site is obtained. In addition, when the lithium amide compound of the latter is used, a conjugated diene-based polymer which has a nitrogen-containing group at a polymerization initiation end and in which the other end is a polymerization active site is obtained.

The hydrocarbyllithium is preferably one having a hydrocarbyl group having 2 to 20 carbon atoms, and examples thereof include ethyllithium, n-propyllithium, isopropyllithium, n-butyllithium, sec-butyllithium, tert-octyllithium, n-decyllithium, phenyllithium, 2-naphthyllithium, 2-butylphenyllithium, 4-phenylbutyllithium, cyclohexyllithium, cyclopentyllithium, and a reaction product between diisopropenylbenzene and butyllithium, with n-butyllithium being especially suitable.

On the other hand, examples of the lithium amide compound include lithium hexamethyleneimide, lithium pyrrolidide, lithium piperidide, lithium heptamethyleneimide, lithium dodecamethyleneimide, lithium dimethylamide, lithium diethylamide, lithium dibutylamide, lithium dipropylamide, lithium diheptylamide, lithium dihexylamide, lithium dioctylamide, lithium di-2-ethylhexylamide, lithium didecylamide, lithium N-methylpiperazide, lithium ethylpropylamide, lithium ethylbutylamide, lithium ethylbenzylamide, and lithium methylphenethylamide. Among them, cyclic lithium amides, such as lithium hexamethyleneimide, lithium pyrrolidide, lithium piperidide, lithium heptamethyleneimide, and lithium dodecamethyleneimide are preferred from the standpoint of an interaction effect relative to the carbon black and a polymerization initiation ability, with lithium hexamethyleneimide and lithium pyrrolidide being especially suitable.

In general, though compounds prepared in advance from a secondary amine and a lithium compound can be used for the lithium amide compound, they can be prepared as well in the polymerization system (in-Situ). In addition, the use amount of this polymerization initiator is selected preferably within a range of 0.2 to 20 mmol per 100 g of the monomer.

A method for producing the conjugated diene-based polymer through anionic polymerization using the aforementioned organic lithium compound as the polymerization initiator is not particularly limited, and conventionally known methods can be adopted.

Specifically, the targeted conjugated diene-based polymer having an active end is obtained by subjecting a conjugated diene compound or a conjugated diene compound and an aromatic vinyl compound to anionic polymerization in an organic solvent which is inert to the reaction, for example, a hydrocarbon-based solvent, such as an anliphatic, alicyclic, or aromatic hydrocarbon compound, by using the aforementioned lithium compound as the polymerization initiator in the presence of a randomizer which is used, if desired.

In addition, in the case of using the organic lithium compound as the polymerization initiator, not only the conjugated diene-based polymer having an active end but also the copolymer of the conjugated diene compound having an active end and the aromatic vinyl compound can be efficiently obtained, as compared with the case of using the aforementioned catalyst containing a lanthanum series rare earth element compound.

The hydrocarbon base solvent is preferably a hydrocarbon having 3 to 8 carbon atoms, and examples thereof include propane, n-butane, isobutane, n-pentane, isopentane, n-hexane, cyclohexane, propene, 1-butene, isobutene, trans-2-butene, cis-2-butene, 1-pentene, 2-pentene, 1-hexene, 2-hexene, benzene, toluene, xylene, and ethylbenzene. They may be used alone or may be used in admixture of two or more thereof.

A concentration of the monomer in the solvent is preferably 5 to 50% by mass, and more preferably 10 to 30% by mass. In the case of performing copolymerization using the conjugated diene compound and the aromatic vinyl compound, the content of the aromatic vinyl compound in the charged monomer mixture is preferably in a range of 55% by mass or less.

The randomizer which is used, if desired refers to a compound having an action of controlling a micro structure of the conjugated diene-based polymer, for example, an increase in a 1,2-bond of a butadiene moiety in a butadiene-styrene copolymer or a 3,4-bond in an isoprene polymer; or controlling a composition distribution of a monomer unit in a conjugated diene compound-aromatic vinyl compound copolymer, for example, randomization of a butadiene unit or a styrene unit in a butadiene-styrene copolymer. This randomizer is not particularly limited, and an optional compound can be appropriately selected and used among known compounds which are conventionally generally used as the randomizer. Specifically, examples thereof include ethers and tertiary amines, such as dimethoxybenzene, tetrahydrofuran, dimethoxyethane, diethylene glycol dibutyl ether, diethylene glycol dimethyl ether, an oxolanylpropane oligomer [especially an oligomer containing 2,2-bis(2-tetrahydrofuryl)-propane)], triethylamine, pyridine, N-methylmorpholine, N,N,N′,N′-tetramethylethylenediamine, and 1,2-dipiperidinoethane. In addition, potassium salts, such as potassium tert-amylate and potassium tert-butoxide, and sodium salts, such as sodium tert-amylate, can also be used.

Such a randomizer may be used alone or may be used in combination of two or more thereof. In addition, the use amount thereof is preferably selected within a range of 0.01 to 1000 molar equivalent per mole of the lithium compound.

Atemperature in the polymerization reaction is selected within a range of preferably 0 to 150° C., and more preferably 20 to 130° C. Although the polymerization reaction can be performed under a generated pressure, typically, it is desirably operated at a pressure sufficient for maintaining the monomer substantially in a liquid phase. That is, though the pressure varies with the respective materials to be polymerized, the polymerization medium to be used, the polymerization temperature, and so on, a higher pressure can be adopted, if desired. Such a pressure is obtained by a suitable method, such as pressurization of a reactor with an inert gas regarding the polymerization reaction.

### (Modifying Agent)

In the present invention, a primary amine-modified conjugated diene-based polymer can be produced by allowing the active end of the conjugated diene-based polymer having an active end obtained as mentioned above to react with a protected primary amine compound as a modifying agent; and a secondary amine-modified conjugated diene-based polymer can be produced by allowing it to react with a protected secondary amine compound. The protected primary amine compound is suitably an alkoxysilane compound having a protected primary amine group, and the protected secondary amine compound is suitably an alkoxysilane compound having a protected secondary amine group.

Examples of the alkoxysilane compound having a protected primary amino group which is used as the modifying agent include N,N-bis(trimethylsilyl)aminopropylmethyldimethoxysilane, 1-trimethylsilyl-2,2-dimethoxy-1-aza-2-silacyclopentane, N,N-bis(trimethylsilyl)aminopropyltrimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)aminoethyltriethoxysilane, N,N-bis(trimethylsilyl)aminoethylmethyldimethoxysilane, and N,N-bis(trimethylsilyl)aminoethylmethyldiethoxysilane, with N,N-bis(trimethylsilyl)aminopropylmethyldimethoxysilane, N,N-bis(trimethylsilyl)aminopropylmethyldiethoxysilane, or 1-trimethylsilyl-2,2-dimethoxy-1-aza-2-silacyclopentanebeingpreferred.

In addition, examples of the modifying agent include alkoxysilane compounds having a protected secondary amino group, such as N-methyl-N-trimethylsilylaminopropyl(methyl)dimethoxysilane, N-methyl-N-trimethylsilylaminopropyl(methyl)diethoxysilane, N-trimethylsilyl(hexamethyleneimine-2-yl)propyl(methyl)dimethoxysilane, N-trimethylsilyl(hexamethyleneimine-2-yl)propyl(methyl)diethoxysilane, N-trimethylsilyl(pyrrolidin-2-yl)propyl(methyl)dimethoxysilane, N-trimethylsilyl(pyrrolidin-2-yl)propyl(methyl)diethoxysilane, N-trimethylsilyl(piperidin-2-yl)propyl(methyl)dimethoxysilane, N-trimethylsilyl(piperidin-2-yl)propyl(methyl)diethoxysilane, N-trimethylsilyl(imidazol-2-yl)propyl(methyl)dimethoxysilane, N-trimethylsilyl(imidazol-2-yl)propyl(methyl)diethoxysilane, N-trimethylsilyl(4,5-dihydroimidazol-5-yl)propyl(methyl)dimethoxysilane, and N-trimethylsilyl(4,5-dihydroimidazol-5-yl)propyl(methyl)diethoxysilane; alkoxysilane compounds having an imino group, such as N-(1,3-dimethylbutylidene)-3-(triethoxysilyl)-1-propanamine, N-(1-methylethylidene)-3-(triethoxysilyl)-1-propanamine, N-ethylidene-3-(triethoxysilyl)-1-propanamine, N-(1-methylpropylidene)-3-(triethoxysilyl)-1-propanamine, N-(4-N,N-dimethylaminobenzylidene)-3-(triethoxysilyl)-1-propanamine, and N-(cyclohexylidene)-3-(triethoxysilyl)-1-propanamine; and alkoxysilane compounds having an amino group, such as 3-dimethylaminopropyl(triethoxy)silane, 3-dimethylaminopropyl(trimethoxy)silane, 3-diethylaminopropyl(triethoxy)silane, 3-diethylaminopropyl(trimethoxy)silane, 2-dimethylaminoethyl(triethoxy)silane, 2-dimethylaminoethyl(trimethoxy)silane, 3-dimethylaminopropyl(diethoxy)methylsilane, and 3-dibutylaminopropyl(triethoxy)silane.

These modifying agents may be used alone or may be used in combination of two or more thereof. In addition, this modifying agent may be a partial condensation product.

The partial condensation product as referred to herein refers to a compound in which a part (not all) of SiOR of the modifying agent is converted into a SiOSi bond through condensation. R represents a hydrocarbon group, such as an alkyl group.

In the modification reaction owing to the modifying agent, the use amount of the modifying agent is preferably 0.5 to 200 (mmol/kg)×(mass of conjugated diene-based polymer (kg)). The use amount is more preferably 1 to 100 (mmol/kg)×(mass of conjugated diene-based polymer (kg)), and especially preferably 2 to 50 (mmol/kg)×(mass of conjugated diene-based polymer (kg)). The conjugated diene-based polymer as referred to herein means a mass of the polymer alone which does not contain an additive, such as an anti-aging agent to be added during the production or after the production. By regulating the use amount of the modifying agent to the aforementioned range, excellent dispersibility of the filler, especially the carbon black is revealed, and rapture resistance characteristics and low heat generation property after vulcanization are improved.

An addition method of the modifying agent is not particularly limited, and examples thereof includes a method in which it is added in one lot, a method in which it is added in a divided lot, and a method in which it is added continuously, with a method in which it is added in one lot being preferred.

Although the modifying agent can be bonded to any of a principal chain and a side chain of the polymer in addition to a polymerization initiating end and a polymerization finishing end thereof, it is preferably introduced into the polymerization initiating end or the polymerization finishing end from the standpoint that energy can be inhibited from disappearing from an end of the polymer to improve the low heat generation property.

### (Condensation Accelerator)

In the present invention, it is preferred to use a condensation accelerator for the purpose of accelerating a condensation reaction in which the alkoxysilane compound having a protected primary amino group to be used as the modifying agent participates.

As the condensation accelerator, a compound having a tertiary amino group, or an organic compound having at least one element belonging to any of the group 3, the group 4, the group 5, the group 12, the group 13, the group 14, and the group 15 in the periodic table (long-form periodic table) can be used. Furthermore, the condensation accelerator is preferably an alkoxide, a carboxylate, or an acetylacetonate complex salt, each of which contains at least one metal selected from the group consisting of titanium (Ti), zirconium (Zr), bismuth (Bi), aluminum (Al), and tin (Sn).

Although the condensation accelerator as used herein can be added before the modification reaction, it is preferably added to the modification reaction system on the way and/or after completion of the modification reaction. In the case where it is added before the modification reaction, there is a concern that a direction reaction with the active end occurs, so that the hydrocarbyloxy group having the protected primary amino group is not introduced into the active end.

An addition timing of the condensation accelerator is typically a period of 5 minutes to 5 hours after commencement of the modification reaction, and preferably a period of 15 minutes to 1 hour after commencement of the modification reaction.

Specifically, examples of the condensation accelerator include compounds containing titanium, such as tetramethoxytitanium, tetraethoxytitanium,tetra-n-propoxytitanium,tetraisopropoxytitanium,tetra-n-butoxytitanium, a tetra-n-butoxytitanium oligomer, tetra-sec-butoxytitanium, tetra-tert-butoxytitanium, tetra(2-ethylhexyl)titanium, bis(octanedioleate)bis(2-ethylhexyl)titanium, tetra(octanedioleate)titanium, titanium lactate, titanium dipropoxybis(triethanolaminate), titanium dibutoxybis(triethanolaminate), titanium tributoxystearate, titanium tripropoxystearate, titanium ethylhexyldioleate, titanium tripropoxyacetylacetonate, titanium dipropoxybis(acetylacetonate), titanium tripropoxyethylacetoacetate, titanium propoxyacetylacetonatebis(ethylacetoacetate), titanium tributoxyacetylacetonate, titanium dibutoxybis(acetylacetonate), titanium tributoxyethylacetoacetate, titanium butoxyacetylacetonatebis(ethylacetoacetate), titanium tetrakis(acetylacetonate), titanium diacetylacetonatebis(ethylacetoacetate), bis(2-ethylhexanoate)titanium oxide, bis(laurate)titanium oxide, bis(naphthenate)titanium oxide, bis(stearate)titanium oxide, bis(oleate)titanium oxide, bis(linoleate)titanium oxide, tetrakis(2-ethylhexanoate)titanium, tetrakis(laurate)titanium, tetrakis(naphthenate)titanium, tetrakis(stearate)titanium, tetrakis(oleate)titanium, and tetrakis(linoleate)titanium.

In addition, examples of the condensation accelerator include tris(2-ethylhexanoate)bismuth, tris(laurate)bismuth, tris(naphthenate)bismuth, tris(stearate)bismuth, tris(oleate)bismuth, tris(linoleate)bismuth, tetraethoxyzirconium, tetra-n-propoxyzirconium, tetraisopropoxyzirconium, tetra-n-butoxyzirconium, tetra-sec-butoxyzirconium, tetra-tert-butoxyzirconium, tetra(2-ethylhexyl)zirconium, zirconium tributoxystearate, zirconium tributoxyacetylacetonate, zirconium dibutoxybis(acetylacetonate), zirconium tributoxyethylacetoacetate, zirconium butoxyacetylacetonatebis(ethylacetoacetate), zirconium tetrakis(acetylacetonate), zirconium diacetylacetonatebis(ethylacetoacetate), bis(2-ethylhexanoate)zirconium oxide, bis(laurate)zirconium oxide, bis(naphthenate)zirconium oxide, bis(stearate)zirconium oxide, bis(oleate)zirconium oxide, bis(linoleate)zirconium oxide, tetrakis(2-ethylhexanoate)zirconium, tetrakis(laurate)zirconium, tetrakis(naphthenate)zirconium, tetrakis(stearate)zirconium, tetrakis(oleate)zirconium, and tetrakis(linoleate)zirconium.

In addition, examples of the condensation accelerator include triethoxyaluminum, tri-n-propoxyaluminum, triisopropoxyaluminum, tri-n-butoxyaluminum, tri-sec-butoxyaluminum, tri-tert-butoxyaluminum, tri(2-ethylhexyl)aluminum, aluminum dibutoxystearate, aluminum dibutoxyacetylacetonate, aluminum butoxybis(acetylacetonate), aluminum dibutoxyethylacetoacetate, aluminum tris(acetylacetonate), aluminum tris(ethylacetoacetate), tris(2-ethylhexanoate)aluminum, tris(laurate)aluminum, tris(naphthenate)aluminum, tris(stearate)aluminum, tris(oleate)aluminum, and tris(linoleate)aluminum.

Among the aforementioned condensation accelerators, titanium compounds are preferred, and an alkoxide of titanium metal, a carboxylate of titanium metal, or an acetylacetonate complex salt of titanium metal is especially preferred.

The use amount of the condensation accelerators is preferably 0.1 to 10, and especially preferably 0.5 to 5 in terms of a molar ratio of the molar number of the aforementioned compound to the total amount of the hydrocarbyloxy groups present in the reaction system. By regulating the use amount of the condensation accelerator to the aforementioned range, the condensation reaction is efficiently advanced.

The condensation reaction time is typically about 5 minutes to 10 hours, and preferably about 15 minutes to 5 hours. By regulating the condensation reaction time to the aforementioned range, the condensation reaction can be smoothly completed.

In addition, a pressure of the reaction system during the condensation reaction is typically 0.01 to 20 MPa, and preferably 0.05 to 10 MPa.

As for the modified rubber, its number average molecular weight (Mn) is preferably 100,000 to 500,000, and more preferably 150,000 to 300,000. By allowing the number average molecular weight of the modified rubber to fall within the aforementioned range, not only the run flat durability can be more enhanced, but also an excellent kneading operability of the rubber composition containing a modified rubber is obtained.

From the viewpoint of enhancing the low heat generation property of the side reinforcing rubber, the modified rubber is preferably an amine-modified polybutadiene, more preferably a primary amine-modified polybutadiene or a secondary amine-modified polybutadiene, and especially preferably a primary amine-modified polybutadiene.

As for the modified rubber, its vinyl bond content of the butadiene moiety is preferably 10 to 60% by mass, and more preferably 12 to 60% by mass; its Mw is preferably 100,000 to 500,000; its Mw/Mn is preferably 2 or less; and its primary amino group content is preferably 2.0 to 10.0 mmol/kg.

### [Filler]

### (Carbon Black)

The rubber composition of the present invention contains a filler containing a carbon black A having a nitrogen adsorption specific surface area of 20 to 60 m²/g and a carbon black B having a nitrogen adsorption specific surface area of 100 to 150 m²/g, a ratio (a/b) of the content a of the carbon black A to the content b of the carbon black B being 2.7 to 10.

In view of the fact that the filler contains the two kinds of carbon blacks having a different nitrogen adsorption specific surface area from each other in a specified ratio, the rigidity of the side reinforcing rubber that is the vulcanized rubber of the rubber composition of the present invention is enhanced, and a run flat tire having excellent run flat durability can be produced.

The filler may further contain other carbon black than the carbon blacks A and B to an extent that the effects of the present invention are not impaired.

When the nitrogen adsorption specific surface area of the carbon black A is less than 20 m²/g, the gap between the particles of the carbon black A becomes large, the network between the rubber component and the carbon black is liable to be hindered, and the run flat durability is not excellent.

When the nitrogen adsorption specific surface area of the carbon black A is more than 60 m²/g, an effect utilizing a difference in size from the carbon black B is hardly obtained.

The nitrogen adsorption specific surface area of the carbon black A is preferably 30 to 50 m²/g.

When the nitrogen adsorption specific surface area of the carbon black B is less than 100 m²/g, an effect utilizing a difference in size from the carbon black A is hardly obtained.

When the nitrogen adsorption specific surface area of the carbon black B is more than 150 m²/g, the gap between the particles of the carbon black B becomes large, the network between the rubber component and the carbon black is liable to be hindered, and the run flat durability is not excellent.

The nitrogen adsorption specific surface area of the carbon black B is preferably 110 to 130 m²/g.

The ratio (a/b) of the content a of the carbon black A to the content b of the carbon black B is 2.7 to 10. When the ratio (a/b) falls outside the aforementioned range, the carbon black A or the carbon black B becomes excessive, and the network between the rubber component and the carbon black is hindered, and therefore, the run flat durability cannot be enhanced.

The ratio (a/b) is preferably 2.8 to 10, more preferably 3.1 to 10, sill more preferably 3.6 to 10, and yet still more preferably 3.6 to 9.

From the viewpoint of enhancing the reinforcement of the rubber composition to more enhance the run flat durability of the tire, a total amount (a+b) of the content a of the carbon black A and the content b of the carbon black B is preferably 30 to 80 parts by mass, more preferably 40 to 70 parts by mass, and still more preferably 45 to 60 parts by mass based on 100 parts by mass of the rubber component.

As for the content a of the carbon black A and the content b of the carbon black B in the rubber composition, from the viewpoint of making the network between the rubber component and the carbon black more enriched and more enhancing the run flat durability of the tire, the content a is preferably 23 to 73 parts by mass, more preferably 30 to 60 parts by mass, and still more preferably 40 to 55 parts by mass based on 100 parts by mass of the rubber component. In addition, from the same viewpoint, the content b is preferably 3 to 22 parts by mass, more preferably 3 to 18 parts by mass, and still more preferably 3 to 15 parts by mass based on 100 parts by mass of the rubber component.

In order to enhance the rigidity of the side reinforcing rubber for run flat tires, the rubber composition of the present invention may contain other filler than the carbon black, for example, a reinforcing filler, such as silica, and an organic reinforcing material, for example, an organic reinforcing material, such as a syndiotactic 1,2-polybutadiene resin, a polyethylene resin, and a polypropylene resin.

### [Vulcanizing Agent]

The rubber composition of the present invention contains a vulcanizing agent.

The vulcanizing agent is not particularly limited, and sulfur is typically used. Examples thereof include powdery sulfur, precipitated sulfur, colloidal sulfur, surface-treated sulfur, and insoluble sulfur.

The content of the vulcanizing agent is preferably 1 to 10 parts by mass based on 100 parts by mass of the rubber component. When this content is 1 part by mass or more, the vulcanization can be thoroughly advanced, and when it is 10 parts by mass or less, the aging resistance of the side reinforcing rubber for run flat tires can be suppressed.

The content of the vulcanizing agent in the rubber composition is more preferably 2 to 8 parts by mass based on 100 parts by mass of the rubber component.

### [Vulcanization Accelerator]

The rubber composition contains a vulcanization accelerator.

Examples of the vulcanization accelerator include a sulfenamide-based vulcanization accelerator, a thiazole-based vulcanization accelerator, a dithiocarbamate-based vulcanization accelerator, a xanthate-based vulcanization accelerator, and a thiuram-based vulcanization accelerator.

In view of the fact that the rubber composition contains the vulcanization accelerator, a run flat tire which is excellent in run flat durability can be obtained.

Examples of the sulfenamide-based vulcanization accelerator include N-cyclohexyl-2-benzothiazolyl sulfenamide, N,N-dicyclohexyl-2-benzothiazolyl sulfenamide, N-tert-butyl-2-benzothiazolyl sulfenamide, N-oxydiethylene-2-benzothiazolyl sulfenamide, N-methyl-2-benzothiazolyl sulfenamide, N-ethyl-2-benzothiazolyl sulfenamide, N-propyl-2-benzothiazolyl sulfenamide, N-butyl-2-benzothiazolyl sulfenamide, N-pentyl-2-benzothiazolyl sulfenamide, N-hexyl-2-benzothiazolyl sulfenamide, N-heptyl-2-benzothiazolyl sulfenamide, N-octyl-2-benzothiazolyl sulfenamide, N-2-ethylhexyl-2-benzothiazolyl sulfenamide, N-decyl-2-benzothiazolyl sulfenamide, N-dodecyl-2-benzothiazolyl sulfenamide, N-stearyl-2-benzothiazolyl sulfenamide, N,N-dimethyl-2-benzothiazolyl sulfenamide, N,N-diethyl-2-benzothiazolyl sulfenamide, N,N-dipropyl-2-benzothiazolyl sulfenamide, N,N-dibutyl-2-benzothiazolyl sulfenamide, N,N-dipentyl-2-benzothiazolyl sulfenamide, N,N-dihexyl-2-benzothiazolyl sulfenamide, N,N-diheptyl-2-benzothiazolyl sulfenamide, N,N-dioctyl-2-benzothiazolyl sulfenamide, N,N-di-2-ethylhexylbenzothiazolyl sulfenamide, N-decyl-2-benzothiazolyl sulfenamide, N,N-didodecyl-2-benzothiazolyl sulfenamide, and N,N-distearyl-2-benzothiazolyl sulfenamide. Among them, N-cyclohexyl-2-benzothiazolyl sulfenamide and N-tert-butyl-2-benzothiazolyl sulfenamide are preferred because of high reactivity.

Examples of the thiazole-based vulcanization accelerator include 2-mercaptobenzothiazole, di-2-benzothiazolyl disulfide, a zinc salt of 2-mercaptobenzothiazole, a cyclohexylamine salt of 2-mercaptobenzothiazole, 2-(N,N-diethylthiocarbamoylthio)benzothiazole, 2-(4′-morpholinodithio)benzothiazole, 4-methyl-2-mercaptobenzothiazole, di-(4-methyl-2-benzothiazolyl) disulfide, 5-chloro-2-mercaptobenzothiazole, sodium 2-mercaptobenzothiazole, 2-mercapto-6-nitrobenzothiazole, 2-mercapto-naphtho[1,2-d]thiazole, 2-mercapto-5-methoxybenzothiazole, and 6-amino-2-mercaptobenzothiazole. Among them, 2-mercaptobenzothiazole and di-2-benzothiazolyl disulfide are preferred because of high reactivity.

Examples of the dithiocarbamate-based vulcanization accelerator include zinc dimethyldithiocarbamate, zinc diethyldithiocarbamate, zinc dibutyldithiocarbamate, zinc ethylphenyldithiocarbamate, zinc N-pentamethylenedithiocarbamate, zinc dibenzyldithiocarbamate, sodium dibutyldithiocarbamate, copper dimethyldithiocarbamate, ferric dimethyldithiocarbamate, and telluriumdiethyldithiocarbamate.

Examples of the xanthate-based vulcanization accelerator include zinc methylxanthate, zinc ethylxanthate, zinc propylxanthate, zinc isopropylxanthate, zinc butylxanthate, zinc pentylxanthate, zinc hexylxanthate, zinc heptylxanthate, zinc octylxanthate, zinc 2-ethylhexylxanthate, zinc decylxanthate, zinc dodecylxanthate, potassium methylxanthate, potassium ethylxanthate, potassium propylxanthate, potassium isopropylxanthate, potassium butylxanthate, potassium pentylxanthate, potassium hexylxanthate, potassium heptylxanthate, potassium octylxanthate, potassium 2-ethylhexylxanthate, potassium decylxanthate, potassium dodecylxanthate, sodium methylxanthate, sodium ethylxanthate, sodium propylxanthate, sodium isopropylxanthate, sodium butylxanthate, sodium pentylxanthate, sodium hexylxanthate, sodium heptylxanthate, sodium octylxanthate, sodium 2-ethylhexylxanthate, sodium decylxanthate, and sodium dodecylxanthate.

The thiuram-based vulcanization accelerator is preferably a thiuram-based compound having a side chain carbon number of 4 or more. The side chain carbon number of the thiuram-based compound is more preferably 6 or more, and still more preferably 8 or more. In view of the fact that the side chain carbon number of the thiuram-based component is 4 or more, dispersion of the thiuram compound in the rubber composition is excellent, a uniform crosslinking network is readily constituted, the rigidity of the side reinforcing rubber is readily enhanced, and the run flat durability of the tire is readily enhanced.

Examples of the thiuram compound having the side chain carbon number of 4 or more include tetrakis(2-ethylhexyl)thiuram disulfide, tetrakis(n-dodecyl)thiuram disulfide, tetrakis(benzyl)thiuram disulfide, tetrabutylthiuram disulfide, dipentamethylenethiuram tetrasulfide, and tetrabenzylthiuram disulfide. Above all, tetrakis(2-ethylhexyl)thiuram disulfide is preferred.

Among the foregoing vulcanization accelerators, a thiuram-based vulcanization accelerator, a thiazole-based vulcanization accelerator, and a sulfenamide-based vulcanization accelerator are preferred. The vulcanization accelerator may be used alone or may be used in combination of two or more thereof.

From the viewpoint of more enhancing the run flat durability of the tire, the vulcanization accelerator preferably contains at least one thiuram-based vulcanization accelerator, and a combination of the thiuram-based vulcanization accelerator and the sulfenamide-based vulcanization accelerator is preferred.

Furthermore, from the viewpoint of more enhancing the run flat durability of the tire, when sulfur is used as the vulcanizing agent, and a thiuram-based vulcanization accelerator is used as the vulcanization accelerator, a ratio (s/t) of the content s of the sulfur to the content t of the thiuram-based vulcanization accelerator is preferably 1 to 10. In the case where the ratio (s/t) is 1 or more, a sufficient hardness required as the reinforcing rubber can be revealed, and in the case where it is 10 or less, a firm crosslinking structure at the time of a high temperature can be formed. The ratio (s/t) is more preferably 1 to 4.

In the rubber composition of the present invention, a compounding agent which is mixed in a typical rubber composition and used can be contained together with the aforementioned components. Examples thereof include various compounding agents which are generally mixed, such as a silane coupling agent, a vulcanization acceleration aid, a vulcanization retarder, a softener, e.g., various process oils, zinc oxide, stearic acid, a wax, an anti-aging agent, a compatibilizer, a workability improver, a lubricant, a tackifier, a petroleum-based resin, an ultraviolet absorber, a dispersant, and a homogenizing agent.

As the anti-aging agent, known anti-aging agents can be used and are not particularly limited. Examples thereof include a phenol-based anti-aging agent, an imidazole-based anti-aging agent, and an amine-based anti-aging agent. The mixing amount of such an anti-aging agent is typically 0.1 to 5 parts by mass, and preferably 0.5 to 3 parts by mass based on 100 parts by mass of the rubber component.

On the occasion of obtaining the rubber composition, a mixing method of the aforementioned respective components is not particularly limited, and all of the component raw materials may be mixed and kneaded at once, or the respective components may be mixed and kneaded in separate two steps or three steps. On the occasion of performing kneading, a kneading machine, such as a roll, an internal mixer, and a Banbury rotor, can be used. Furthermore, on the occasion of molding in a sheet-like form, a stripe-like form, or the like, a known molding machine, such as an extrusion molding machine and a press machine, may be used.

The vulcanized rubber of the rubber composition thus obtained readily has such characteristics that a 50% modulus value at 25° C. is 4.0 to 6.0 MPa and is excellent in rigidity.

The 50% modulus value at 25° C. of the vulcanized rubber is measured in terms of a tensile elastic modulus during 50% elongation of the vulcanized rubber at a temperature of 25° C. on the basis of JIS K6251 (2017).

### <Side Reinforcing Rubber for Run Flat Tires and Run Flat Tire>

The side reinforcing rubber for run flat tires of the present invention is made of the side reinforcing rubber composition for run flat tires of the present invention and has a 50% modulus value at 25° C. of 4.0 to 6.0 MPa.

In view of the fact that the run flat tire of the present invention is made of the side reinforcing rubber for run flat tires of the present invention having such a high elastic modulus, it is excellent in run flat durability.

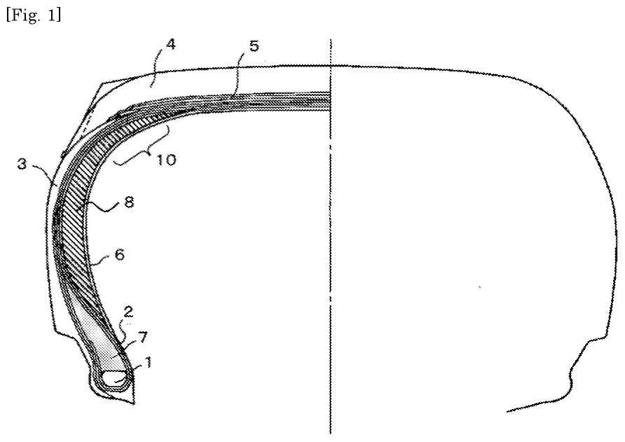

An example of a structure of the run flat tire having a side reinforcing rubber layer is hereunder described by reference to FIG. 1.

FIG. 1 is a schematic view illustrating a cross section of an embodiment of the run flat tire of the present invention and describes an arrangement of respective members constituting the run flat tire of the present invention, such as a side reinforcing rubber layer 8.

In FIG. 1, a suitable embodiment of the run flat tire of the present invention is a tire provided with a carcass layer 2 which is ranged toroidally over a space between a pair of bead cores 1 and 1′ (1′ is not illustrated) and which is formed of at least one radial carcass ply rolling up the bead core 1 from an inside of the tire to an outside thereof at both end parts; a side rubber layer 3 which is arranged at an outside of a tire axial direction in a side region of the carcass layer 2 to form an outside section; a tread rubber layer 4 which is arranged at an outside of a tire diameter direction in a crown region of the carcass layer 2 to form a grounding section; a belt layer 5 which is arranged between the tread rubber layer 4 and the crown region of the carcass layer 2 to form a reinforcing belt; an inner liner 6 which is arranged on the whole surface of the carcass layer 2 at an inside of the tire to form an air proof film; a bead filler 7 which is arranged between a main body portion of the carcass layer 2 extending from one bead core 1 to the other bead core 1′ and a roll-up portion rolled up on the bead core 1; and at least one side reinforcing rubber layer 8 which is arranged between the carcass layer 2 and the inner liner 6 from the bead filler 7 side section to a shoulder zone 10 in a side region of the carcass layer and in which a cross-sectional shape along a rotational axis of the tire is approximately lunate.

The run flat tire of the present invention using the side reinforcing rubber for run flat tires of the present invention for the side reinforcing rubber layer 8 of the tire is excellent in run flat durability.

Although the carcass layer 2 of the run flat tire of the present invention is formed of at least one carcass ply, the carcass ply may also be formed of two or more sheets thereof. In addition, the reinforcing cord of the carcass ply can be arranged at an angle of substantially 90 against the circumferential direction of the tire, and an embedded count of the reinforcing cord can be 35 to 65 pieces/50 mm. In addition, the belt layer 5 to be arranged outside the crown region of the carcass in the radial direction of the tire may be, for example, formed of two layers of a first belt layer and a second belt layer. The number of layers in the belt layer 5 is not limited thereto. As for the first belt layer and the second belt layer, those in which plural steel cords arranged in parallel in the width direction of the tire without being twisted together are embedded in the rubber can be used. For example, by arranging the first belt layer and the second belt layer so as to cross each other between the layers, a crossed belt may be formed.

Furthermore, outside the belt layer 5 in the radial direction of the run flat tire of the present invention, a belt reinforcing layer (not illustrated in the drawing) may be further arranged. The reinforcing cord of the belt reinforcing layer is preferably made from a highly elastic organic fiber for the purpose of securing the tensile rigidity in the circumferential direction of the tire. Organic fiber cords made of an aromatic polyamide (aramid), polyethylene naphthalate (PEN), polyethylene terephthalate, rayon, ZYLON (a registered trademark) (poly-p-phenylenebenzobisoxazole (PBO) fiber), an aliphatic polyamide (nylon), or the like can be used as the organic fiber cord.

Furthermore, in the run flat tire of the present invention, besides the side reinforcing layer, a reinforcing member not illustrated in the drawing, such as an insert and a flipper, may be arranged. Here, the insert is a reinforcing material using plural highly elastic organic fiber cords placed side by side and coated with rubber, so as to be arranged from the bead section to the side section in the circumferential direction of the tire (not illustrated in the drawing). The flipper is a reinforcing material made of plural highly elastic organic fiber cords placed side by side and coated with rubber; arranged between the main body portion of the carcass ply extending between the bead core 1 and 1′ and, a folding portion of the carcass ply folded around the bead core 1 or 1′; involving bead core 1 or 1′, and at least a part of the bead filler 7 arranged outside thereof in the radial direction of the tire. The angle of the insert and the flipper is preferably 30 to 60 to the circumferential direction.

The tire of the present invention has a pair of bead sections in which the bead cores 1 and 1′ are embedded, respectively. The carcass layer 2 is folded around the bead cores 1 and 1′ from the inside to the outside of the tire so as to be engaged. A method for engaging the carcass layer 2 is not limited thereto. For example, at least one carcass ply of the carcass plies constituting the carcass layer 2 may be folded around the bead cores 1 and 1′ from the inside toward the outside in the tire width direction, so as to form a so-called envelope structure in which the folded end is positioned between the belt layer 5 and the crown portion of the carcass layer 2. Furthermore, a tread pattern may be appropriately formed on the surface of the tread rubber layer 4, and the inner liner 6 may be formed in the innermost layer. In the run flat tire of the present invention, a gas, such as normal air or air in which a partial oxygen pressure has been changed, or an inert gas, such as nitrogen, can be used as the gas to be filled in the tire.

### (Preparation of Side Reinforcing Rubber for Run Flat Tires and Run Flat Tire)

A run flat tire provided with a side reinforcing rubber for run flat tires is obtained by a typical method for producing a run flat tire by using the side reinforcing rubber composition for run flat tires of the present invention for the side reinforcing rubber layer 8.

That is, the rubber composition containing various chemicals is processed in respective members in an unvulcanization stage, and the members are stuck and molded on a tire molding machine by a conventional method, thereby molding a green tire. The green tire is heated and pressurized in a vulcanizing machine to obtain a side reinforcing rubber for run flat tires and a run flat tire.

### EXAMPLES

### Examples 1 to 3 and Comparative Examples 1 to 5

### [Preparation of Rubber Composition]

Respective components were kneaded in a mixing composition shown in the following Table 1, thereby preparing rubber compositions.

A modified butadiene rubber (modified BR) used for the preparation of the rubber composition was produced by the following methods.

### [Production of Primary Amine-Modified Butadiene Rubber (Modified BR)]

### (1) Production of Unmodified Polybutadiene

A 5-liter autoclave purged with nitrogen was charged with 1.4 kg of cyclohexane, 250 g of 1,3-butadiene, and 2,2-ditetrahydrofurylpropane (0.285 mmol) in the form of a cyclohexane solution under nitrogen, and after 2.85 mmol of n-butyllithium (BuLi) was added thereto, polymerization was performed for 4.5 hours in a warm water bath of 50° C. equipped with a stirring device. A reaction conversion rate of 1,3-butadiene was almost 100%. Apart of this polymer solution was put in a methanol solution containing 1.3 g of 2,6-di-tert-butyl-p-cresol, to terminate the polymerization, and then, the solvent was removed by steam stripping. The residue was dried on a roll of 110° C. to obtain polybutadiene before modification.

The obtained polybutadiene before modification was used to measure a micro structure (vinyl bond amount), a weight average molecular weight (Mw), and a molecular weight distribution (Mw/Mn). As a result, the vinyl bond amount was 30% by mass, Mw was 150,000, and Mw/Mn was 1.1.

### (2) Production of Primary Amine-Modified Butadiene Rubber

The polymer solution obtained in the above (1) was maintained at a temperature of 50° C. without deactivating the polymerization catalyst, and 1,129 mg (3.364 mmol) of N,N-bis(trimethylsilyl)aminopropylmethyldiethoxysilane in which a primary amino group thereof was protected was added thereto, to perform a modification reaction for 15 minutes. Thereafter, 8.11 g of tetrakis(2-ethyl-1,3-hexanediolato)titanium that is a condensation accelerator was added, and the contents were further stirred for 15 minutes. Finally, to the polymer solution after the reaction, 242 mg of silicon tetrachloride as a metal halide compound was added, and 2,6-di-tert-butyl-p-cresol was added. Subsequently desolvation and deprotection of the protected primary amino group were performed by steam stripping, and the rubber was dried with a hot roll which was controlled at a temperature of 110° C., to obtain a primary amine-modified polybutadiene (modified BR).

The obtained modified polybutadiene rubber was used to measure a micro structure (vinyl bond amount), a weight average molecular weight (Mw), a molecular weight distribution (Mw/Mn), and a primary amino group content. As a result, the vinyl bond amount was 30% by mass, Mw was 150,000, Mw/Mn was 1.2, and the primary amino group content was 4.0 mmol/kg.

The micro structure (vinyl bond amount) of each of the polybutadiene rubber before modification and the modified polybutadiene rubber was determined by an infrared method (Morello method) in terms of a vinyl bond content (by mass) of the butadiene moiety.

The weight average molecular weight (Mw) and the molecular weight distribution (Mw/Mn) of each of the polybutadiene rubber before modification and the modified polybutadiene rubber were measured by means of GPC (“HLC-8020”, manufactured by Tosoh Corporation) by using a refractometer as a detector and expressed in terms of polystyrene using monodispersed polystyrene as a standard. The column is GMHXL (manufactured by Tosoh Corporation), and the eluant is tetrahydrofuran.

In addition, the primary amino group content (mmol/kg) of the modified polybutadiene rubber was determined in the following manner.

First, the polymer was dissolved in toluene and then precipitated in a large amount of methanol, to separate an amino group-containing compound which was not bonded to the polymer, from the rubber, followed by drying. The polymer which had been subjected to the present treatment was used as a sample, to quantitatively determine the whole amino group content thereof by “Testing method for total amine values” described in JIS K7237:1995. Subsequently the polymer which had been subjected to the aforementioned treatment was used as a sample, to quantitatively determine the content of each of the secondary amino group and the tertiary amino group by the “acetylacetone blocked method”. o-Nitrotoluene was used as the solvent for dissolving the sample, and acetylacetone was added, to undergo potentiometric titration with a perchloric acetic acid solution. The content of each of the secondary amino group and the tertiary amino group was subtracted from the whole amino group content, to determine the primary amino group content (mmol) and divided by a mass of the polymer used for the analysis, thereby determining the content (mmol/kg) of the primary amino group bonded to the polymer.

Details of the respective components other than the modified polybutadiene rubber (primary amine-modified polybutadiene rubber) as used for preparation of the rubber composition are as follows.

(1) NR: Natural rubber, RSS #1
(2) Carbon black A: a trade name “SEAST F”, manufactured by Tokai Carbon Co., Ltd. (nitrogen adsorption specific surface area=42 m²/g)
(3) Carbon black B: a trade name “VULCAN 7H”, manufactured by Cabot Corporation (nitrogen adsorption specific surface area=117 m²/g)
(4) Carbon black C: a trade name “VULCAN 3”, manufactured by Cabot Corporation (nitrogen adsorption specific surface area=76 m²/g)
(5) Thiuram-based accelerator TOT: Tetrakis(2-ethylhexyl)thiuram disulfide, a trade name “NOCCELER TOT-N”, manufactured by Ouchi Shinko Chemical Industrial Co., Ltd.
(6) Sulfenamide-based accelerator NS: N-(tert-Butyl)-2-benzothiazolyl sulfenamide, a trade name “SANCELER NS-G”, manufactured by Sanshin Chemical Industry Co., Ltd.
(7) Anti-aging agent (6C): N-Phenyl-N′-(1,3-dimethylbutyl)-p-phenylenediamine, a trade name “NOCRAC 6C”, manufactured by Ouchi Shinko Chemical Industrial Co., Ltd.

### [Production and Evaluation of Run Flat Tire]

Subsequently, the resulting rubber compositions were each arranged in the side reinforcing rubber layer 8 as illustrated in FIG. 1, and passenger car radial run flat tires having a tire size of 205/65 R16 were produced, respectively according to a conventional method. The maximum thickness of the side reinforcing rubber layer of the tire was set to 12 mm.

The rubber compositions were each vulcanized under the same condition as in the produced run flat tire, thereby preparing a vulcanized rubber test piece. The vulcanized rubber test piece was measured for a 50% modulus value M50 at 25° C. as the vulcanized rubber physical properties, and the produced run flat tire was evaluated for run flat durability. The results are shown in Table 1.

### 1. Characteristics of Vulcanized Rubber

The vulcanized rubber test piece was processed into a test piece having a dumbbell shape No. 8 and determined for a tensile elastic modulus during 50% elongation at a temperature of 25° C. on the basis of JIS K6251 (2017).

### 2. Run Flat Durability

Drum-running (velocity: 80 km/h) was performed in an inner pressure-unfilled state, and a drum-running distance until the tire became unable to run was defined as a run flat running distance. The run flat running distance was expressed in terms of an index while defining the run flat running distance of the run flat tire of Comparative Example 1 as 100. It is expressed that the larger the index, the more excellent the durability of each of the side reinforcing rubber and the run flat tire provided with the same.

TABLE 1

| | | | Compar- | | | | Compar- | Compar- | Compar- | Compar- |
|---|---|---|---|---|---|---|---|---|---|---|
| | | | ative | | | | ative | ative | ative | ative |
| | | | Example 1 | Example 1 | Examples 2 | Example 3 | Example 2 | Example 3 | Example 4 | Example 5 |
| Rubber | NR | Parts | 30 | 30 | 30 | 30 | 30 | 30 | 30 | 30 |
| component | Modified BR | Parts | 70 | 70 | 70 | 70 | 70 | 70 | 70 | 70 |
| Filler | Carbon black A (a) | Parts | 55 | 50 | 45 | 43 | 40 | 27.5 | 45 | 0 |
| | Carbon black B (b) | Parts | 0 | 5 | 10 | 12 | 15 | 27.5 | 0 | 10 |
| | Carbon black C | Parts | 0 | 0 | 0 | 0 | 0 | 0 | 10 | 45 |
| | a/b | — | — | 10.00 | 4.50 | 3.58 | 2.67 | 1.00 | — | 0.00 |
| Vulcanizing | Sulfur (s) | Parts | 5.5 | 5.5 | 5.5 | 5.5 | 5.5 | 5.5 | 5.5 | 5.5 |
| agent. | Thiuram-based | Parts | 1.8 | 1.8 | 1.8 | 1.8 | 1.8 | 1.8 | 1.8 | 1.8 |
| vulcanization | accelerator TOT (t) | | | | | | | | | |
| accelerator | Sulfenamide-based | Parts | 3 | 3 | 3 | 3 | 3 | 3 | 3 | 3 |
| | accelerator NS | | | | | | | | | |
| | s/t | — | 3.1 | 3.1 | 3.1 | 3.1 | 3.1 | 3.1 | 3.1 | 3.1 |
| Various | Anti-aging agent | Parts | 1 | 1 | 1 | 1 | 1 | 1 | 1 | 1 |
| components | Stearic acid | Parts | 1 | 1 | 1 | 1 | 1 | 1 | 1 | 1 |
| | Zinc oxide | Parts | 3.5 | 3.5 | 3.5 | 3.5 | 3.5 | 3.5 | 3.5 | 3.5 |
| Characteristics | Modulus value (M50) | MPa | 5.3 | 5.2 | 5.0 | 4.9 | 4.8 | 4.7 | 5.0 | 5.8 |
| of vulcanized | | | | | | | | | | |
| rubber | | | | | | | | | | |
| Evaluation | Run flat durability | — | 100 | 116 | 126 | 113 | 61 | 42 | 95 | 83 |
| | (index) | | | | | | | | | |

In Table 1, (a/b) expresses the ratio (a/b) of the content a (parts by mass) of the carbon black A to the content b (parts by mass) of the carbon black B; and (s/t) expresses the ratio (s/t) of the content s (parts by mass) of sulfur to the content t (parts by mass) of the thiuram-based vulcanization accelerator (thiuram-based accelerator TOT).

From Table 1, it is noted that the run flat tires obtained from the rubber compositions of Comparative Examples 1, 4, and 5 each having the side reinforcing rubber obtained in which specified two or more kinds of large and small carbon blacks are not used and the run flat tires obtained from the rubber compositions of Comparative Examples 2 and 3 each having the side reinforcing rubber in which specified two or more kinds of large and small carbon blacks are used but not used in a specified ratio are unable to extend the run flat running distance and are not excellent in run flat durability.

On the other hand, the run flat tires obtained from the rubber compositions of Examples 1 to 3 each having the side reinforcing rubber in which specified two or more kinds of large and small carbon blacks are used in a specified ratio are able to extend the run flat running distance and are excellent in run flat durability.

### INDUSTRIAL APPLICABILITY

The side reinforcing rubber produced using the side reinforcing rubber composition for run flat tires of the present invention has a 50% modulus value at 25° C. of 4.0 to 6.0 MPa, and therefore, it is, for example, suitable for production of a run flat tire for passenger cars.

### REFERENCE SIGNS LIST

1: Bead core
2: Carcass layer
3: Side rubber layer
4: Tread rubber layer
5: Belt layer
6: Inner liner
7: Bead filler
8: Side reinforcing rubber layer
10: Shoulder zone

1. A side reinforcing rubber composition for run flat tires, comprising
a rubber component;
a filler containing a carbon black A having a nitrogen adsorption specific surface area of 20 to 60 m²/g and a carbon black B having a nitrogen adsorption specific surface area of 100 to 150 m²/g, a ratio (a/b) of the content a of the carbon black A to the content b of the carbon black B being 2.7 to 10;
a vulcanizing agent; and
a vulcanization accelerator.

2. The side reinforcing rubber composition for run flat tires according to claim 1, wherein the nitrogen adsorption specific surface area of the carbon black A is 30 to 50 m²/g, and the nitrogen adsorption specific surface area of the carbon black B is 110 to 130 m²/g.

3. The side reinforcing rubber composition for run flat tires according to claim 1, wherein a total amount of the content a of the carbon black A and the content b of the carbon black B is 30 to 80 parts by mass based on 100 parts by mass of the rubber component.

4. The side reinforcing rubber composition for run flat tires according to claim 1, wherein the vulcanizing agent is sulfur, the vulcanization accelerator is a thiuram-based vulcanization accelerator, and a ratio (s/t) of the content s of the sulfur to the content t of thiuram-based vulcanization accelerator is 1 to 10.

5. The side reinforcing rubber composition for run flat tires according to claim 1, wherein as vulcanized rubber characteristics, a 50% modulus value at 25° C. is 4.0 to 6.0 MPa.

6. The side reinforcing rubber composition for run flat tires according to claim 1, wherein the ratio (a/b) of the content a of the carbon black A to the content b of the carbon black B is 3.1 to 10.

7. A side reinforcing rubber for run flat tires using the side reinforcing rubber composition for run flat tires according to claim 1 and having a 50% modulus value at 25° C. of 4.0 to 6.0 MPa.

8. A run flat tire using the side reinforcing rubber for run flat tires according to claim 7.

9. The side reinforcing rubber composition for run flat tires according to claim 2, wherein a total amount of the content a of the carbon black A and the content b of the carbon black B is 30 to 80 parts by mass based on 100 parts by mass of the rubber component.

10. The side reinforcing rubber composition for run flat tires according to claim 2, wherein the vulcanizing agent is sulfur, the vulcanization accelerator is a thiuram-based vulcanization accelerator, and a ratio (s/t) of the content s of the sulfur to the content t of thiuram-based vulcanization accelerator is 1 to 10.

11. The side reinforcing rubber composition for run flat tires according to claim 2, wherein as vulcanized rubber characteristics, a 50% modulus value at 25° C. is 4.0 to 6.0 MPa.

12. The side reinforcing rubber composition for run flat tires according to claim 2, wherein the ratio (a/b) of the content a of the carbon black A to the content b of the carbon black B is 3.1 to 10.

13. A side reinforcing rubber for run flat tires using the side reinforcing rubber composition for run flat tires according to claim 2 and having a 50% modulus value at 25° C. of 4.0 to 6.0 MPa.

14. The side reinforcing rubber composition for run flat tires according to claim 3, wherein the vulcanizing agent is sulfur, the vulcanization accelerator is a thiuram-based vulcanization accelerator, and a ratio (s/t) of the content s of the sulfur to the content t of thiuram-based vulcanization accelerator is 1 to 10.

15. The side reinforcing rubber composition for run flat tires according to claim 3, wherein as vulcanized rubber characteristics, a 50% modulus value at 25° C. is 4.0 to 6.0 MPa.

16. The side reinforcing rubber composition for run flat tires according to claim 3, wherein the ratio (a/b) of the content a of the carbon black A to the content b of the carbon black B is 3.1 to 10.

17. A side reinforcing rubber for run flat tires using the side reinforcing rubber composition for run flat tires according to claim 3 and having a 50% modulus value at 25° C. of 4.0 to 6.0 MPa.

18. The side reinforcing rubber composition for run flat tires according to claim 4, wherein as vulcanized rubber characteristics, a 50% modulus value at 25° C. is 4.0 to 6.0 MPa.

19. The side reinforcing rubber composition for run flat tires according to claim 4, wherein the ratio (a/b) of the content a of the carbon black A to the content b of the carbon black B is 3.1 to 10.

20. A side reinforcing rubber for run flat tires using the side reinforcing rubber composition for run flat tires according to claim 4 and having a 50% modulus value at 25° C. of 4.0 to 6.0 MPa.
